(19) United States
(12) Patent Application Publication
(10) Pub. No.: US 2007/0019253 A1
(43) Pub. Date: Jan. 25, 2007

(54) Scanning device having two sloped surfaces

(75) Inventor: Wei-Pang Huang, Taipei City (TW)

Correspondence Address: BIRCH STEWART KOLASCH & BIRCH, PO BOX 747, FALLS CHURCH, VA, 22040-0747, US

(73) Assignee: Avision Inc.

(21) Appl. No.: 11/488,607

(22) Filed: Jul. 19, 2006

(30) Foreign Application Priority Data
Jul. 22, 2005 (TW) 094124797

(51) Int. Cl. H04N 1/04

(52) U.S. Cl. 358/474

(57) ABSTRACT

A scanning device includes a base, a transparent platen above the base, a left sloped plate connecting a left platen edge of the transparent platen to a left base edge of the base, a right sloped plate connecting a right platen edge of the transparent platen to a right base edge of the base, and a scanning module below the transparent platen. The left sloped plate and the right sloped plate are disposed at two opposite sides of the transparent platen. A left angle between the left sloped plate and the transparent platen and a right angle between the right sloped plate and the transparent platen are greater than 90 degrees. The scanning module is movable along a direction parallel to the right platen edge and the left platen edge so as to acquire an image of a document placed on the transparent platen.

### BACKGROUND OF THE INVENTION

1. Field of the Invention

The invention relates to a scanning device having two sloped surfaces, and more particularly to a book scanning device with two sloped surfaces such that the user does not have to rotate a book as multiple pages of the book are being scanned.

2. Description of the Related Art

FIGS. 1 and 2 are pictorial views showing a conventional book scanner 100 with a single sloped surface so that the image at the book ridge can be scanned. Referring to FIGS. 1 and 2, the conventional book scanner 100 includes a base 101, a transparent platen 102 and a right sloped plate 103. The scanning module (not shown) of the book scanner 100 is moved or moves along the X-axis direction, and the book is located at the end of the moving path of the scanning module. Thus, the scanning module usually has to spend a period of time for the essential movement without any processing.

In addition, the state of the book 20 is shown in FIG. 1 when an odd-numbered page 23 of the book 20 is being scanned, and the state of the book 20 is shown in FIG. 2 when an even-numbered page 24 of the book 20 is being scanned. If the book state has to be changed from that of FIG. 1 to that of FIG. 2, the user has to lift up the book 20 along the Y-axis direction, rotate the book 20 by 180 degrees about the Y-axis, and then put down the book 20. If the page has to be turned over, the user has to lift up the book 20 along the Y-axis direction, turn over the page, rotate the book 20 by 180 degrees about the Y-axis, and then put down the book 20. Because the book 20 has to be rotated by 180 degrees about the Y-axis after each page has been scanned and the page has to be turned over every two pages of the book 20, the user cannot certainly know which page has been scanned, and whether the next page has to be turned over. In addition, when a thick and heavy book is being scanned, the user has a great loading and tends to hurt his or her hand when the book is rotated by 180 degrees about the Y-axis.

Consequently, it is an important subject of the invention to provide a book scanner capable of scanning a book without rotating the book about the Y-axis.

### SUMMARY OF THE INVENTION

It is therefore an object of the invention to provide a scanning device having two sloped surfaces such that a book does not have to be rotated.

Another object of the invention is to provide a scanning device having two sloped surfaces such that the user can prepare for the operation of turning over the page.

To achieve the above-identified objects, the invention provides a scanning device including a base, a transparent platen above the base, a left sloped plate connecting a left platen edge of the transparent platen to a left base edge of the base, a right sloped plate connecting a right platen edge of the transparent platen to a right base edge of the base, and a scanning module below the transparent platen. The left sloped plate and the right sloped plate are disposed at two opposite sides of the transparent platen. A left angle between the left sloped plate and the transparent platen and a right angle between the right sloped plate and the transparent platen are greater than 90 degrees. The scanning module is movable along a direction parallel to the right platen edge and the left platen edge so as to acquire an image of a document placed on the transparent platen.

According to the scanning device of the invention, the user does not have to rotate the book, the user can simply and clearly perform the scanning operations, and the user can prepare for the operation of turning over the page on the left sloped plate or the right sloped plate to speed up the overall scanning operations.

### BRIEF DESCRIPTION OF THE DRAWINGS

FIGS. 1 and 2 are pictorial views showing a conventional book scanner with a single sloped surface.

FIG. 3 is a pictorial view showing a book scanner having two sloped surfaces according to a preferred embodiment of the invention.

FIGS. 4 and 5 are pictorial views showing two states when the book scanner of FIG. 3 is scanning a book.

### DETAILED DESCRIPTION OF THE INVENTION

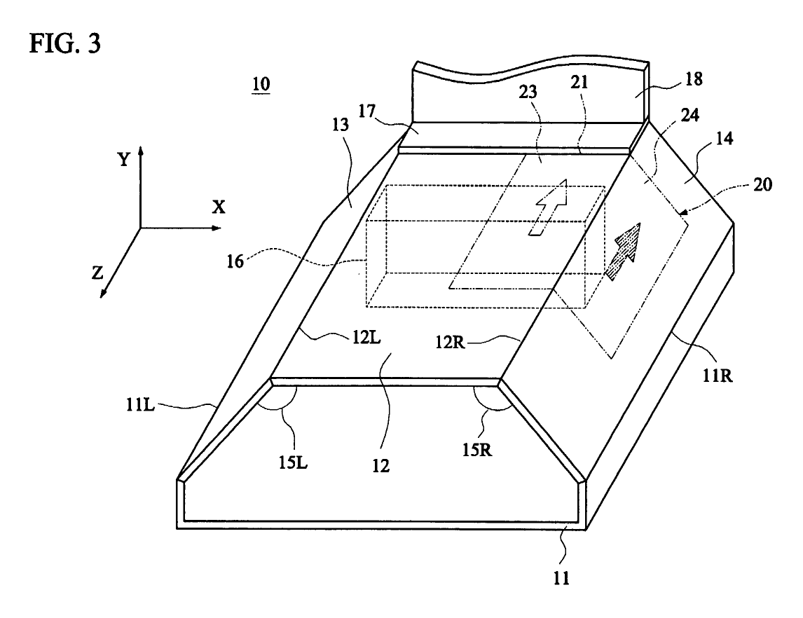

FIG. 3 is a pictorial view showing a book scanner having two sloped surfaces according to a preferred embodiment of the invention. Referring to FIG. 3, a scanning device 10 according to this embodiment includes a base 11, a transparent platen 12, a left sloped plate 13, a right sloped plate 14 and a scanning module 16.

The transparent platen 12 is disposed above the base 11. The left sloped plate 13 connects a left platen edge 12L of the transparent platen 12 to a left base edge 11L of the base 11. The right sloped plate 14 connects a right platen edge 12R of the transparent platen 12 to a right base edge 11R of the base 11. The left sloped plate 13 and the right sloped plate 14 are disposed at two opposite sides of the transparent platen 12. A left angle 15L between the left sloped plate 13 and the transparent platen 12 and a right angle 15R between the right sloped plate 14 and the transparent platen 12 are greater than 90 degrees. Thus, a document 20 such as a book may be commonly supported by the left sloped plate 13 and the transparent platen 12, or by the right sloped plate 14 and the transparent platen 12. The scanning module 16 disposed below the transparent platen 12 is movable along a direction (Z-axis direction) parallel to the right platen edge 12R and the left platen edge 12L so as to acquire an image of the document 20 disposed on the transparent platen 12.

In addition, the scanning device 10 may further include a positioning structure 17 and an upper cover 18. The positioning structure 17 is disposed between the right platen edge 12R and the left platen edge 12L on the transparent platen 12 in order to position the document 20. That is, the front edge 21 of the book 20 may rest against the positioning structure 17 to achieve the positioning effect.

The upper cover 18 is attached to the base 11 and is rotatable about an axis (X-axis) perpendicular to the left platen edge 12L and the right platen edge 12R such that the cover can be lifted and closed on the transparent platen 12. Thus, the scanning device 10 of the invention may also utilize the upper cover 18 to press a typical document and shield the light.

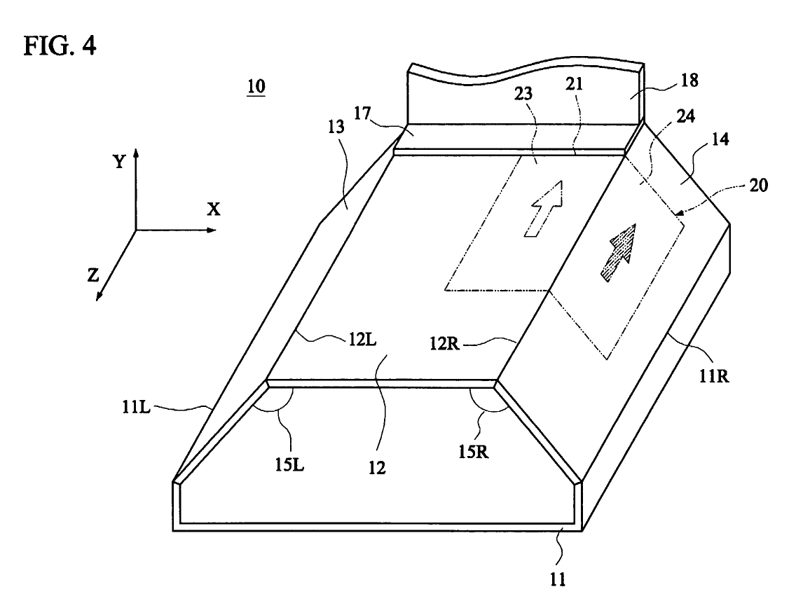

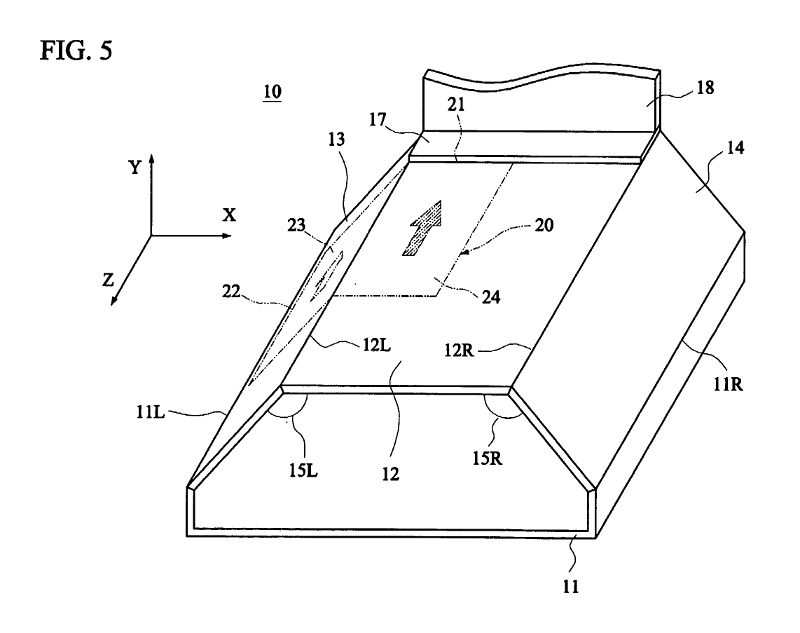

FIGS. 4 and 5 are pictorial views showing two states when the book scanner of FIG. 3 is scanning a book. For the sake of clearness, the scanning module 16 is not depicted in FIGS. 4 and 5. Thus, in addition to the typical document, the scanning device 10 of the invention may also scan a bound document, such as a book. In this case, the right platen edge 12R positions the bound document 20, which is opened and placed on the transparent platen 12 and the right sloped plate 14. That is, the inner gutter side of the book 20 can rest against the right platen edge 12R. Similarly, the left platen edge 12L positions the bound document 20, which is opened and placed on the transparent platen 12 and the left sloped plate 13.

The advantage of providing two sloped plates or two sloped surfaces is that two book positioning modes can be provided. As shown in FIG. 4, the right platen edge 12R positions the book 20, which is opened and placed on the transparent platen 12 and the right sloped plate 14, when the odd-numbered page 23 of the book 20 is being scanned. At this time, the even-numbered page 24 of the book 20 is disposed on the right sloped plate 14. As shown in FIG. 5, the left platen edge 12L positions the book 20, which is opened and placed on the transparent platen 12 and the left sloped plate 13 when the even-numbered page 24 of the book 20 is being scanned. At this time, the odd-numbered page 23 of the book 20 is disposed on the left sloped plate 13. Thus, the state of the book can be changed from that of FIG. 4 to that of FIG. 5 without rotating the book 20 about an axis (Y-axis) perpendicular to the transparent platen 12.

In addition, the positioning structure 17 and the right platen edge 12R can position the bound document 20, which is opened and placed on the transparent platen 12 and the right sloped plate 14, and the positioning structure 17 and the left platen edge 12L can position the bound document 20, which is opened and placed on the transparent platen 12 and the left sloped plate 13 if the positioning structure 17 does exist.

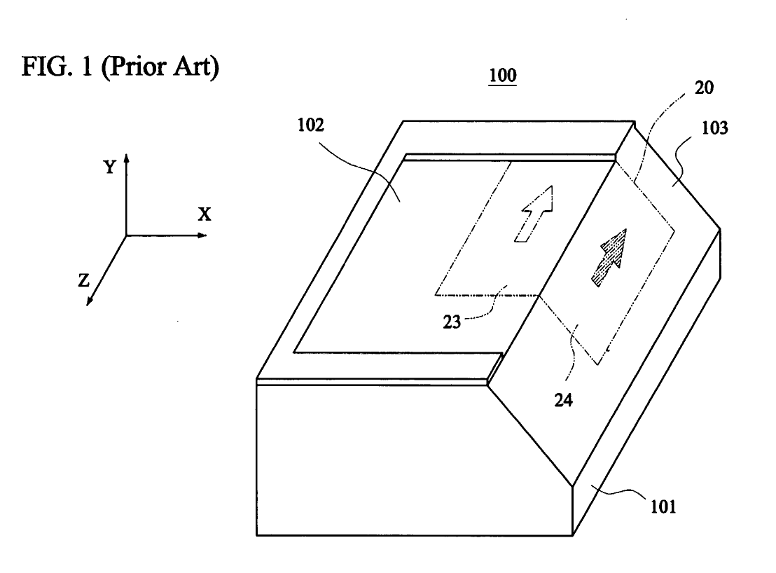

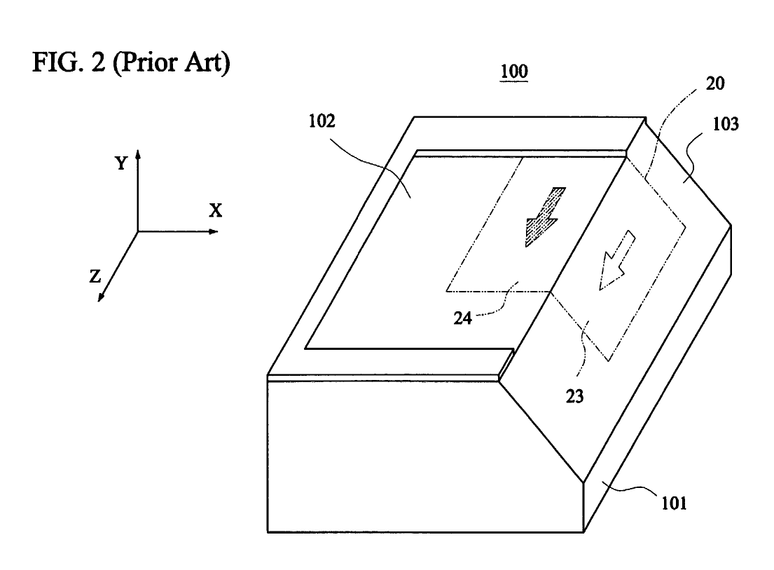

The odd-numbered page 23 of the book 20 can be scanned, as shown in FIG. 4. Then, the book 20 is lifted up along the Y-axis direction, moved leftward along the X-axis direction, and then put down along the Y-axis direction. Thus, the state of the book is changed to that of FIG. 5 and the even-numbered page 24 can be scanned In this case, the user does not have to rotate the book along the Y-axis direction, as shown in FIGS. 1 and 2. So, the user's hands cannot be easily hurt when a thick and heavy book is being scanned. Also, the user can easily make sure which page has been scanned, and how the book has to be placed.

In addition, the scanning device of the invention is also advantageous to the user's preparation for turning over the page of the book as the book is disposed on the left sloped plate 13 or the right sloped plate 14. For example, if the second to fifth pages of the book have to be scanned, the third page of the book can be scanned first, as shown in the FIG. 4. Next, the user moves the book to the state as shown in FIG. 5, and the second page is scanned. Meanwhile, the user can slightly lift up the outer side 22 of the book and perform the preparation operation for turning over the page by separating the page from a next page. After the second page is scanned, the user lifts up the book and turns over the page quickly with the book facing downward, and then places the book on the transparent platen 12, as shown in the state of FIG. 4, and the fifth page can be scanned. Next, the user moves the book to the state as shown in FIG. 5, and the fourth page is scanned. In this case, because the preparation operation is performed on the left sloped plate 13, the user has no confusion and multiple pages of the book can be scanned quickly.

Thus, the scanning device of the invention can provide a method of scanning a book without confusion, and avoid the operation of rotating the book such that the user can easily perform the preparation operation for turning over the page and the scanning operation can be completed quickly.

While the invention has been described by way of examples and in terms of a preferred embodiment, it is to be understood that the invention is not limited thereto. To the contrary, it is intended to cover various modifications. Therefore, the scope of the appended claims should be accorded the broadest interpretation so as to encompass all such modifications.

What is claimed is:

1. A scanning device, comprising:
a base;
a transparent platen disposed above the base;
a left sloped plate connecting a left platen edge of the transparent platen to a left base edge of the base;
a right sloped plate connecting a right platen edge of the transparent platen to a right base edge of the base, wherein the left sloped plate and the right sloped plate are disposed at two opposite sides of the transparent platen, and a left angle between the left sloped plate and the transparent platen and a right angle between the right sloped plate and the transparent platen are greater than 90 degrees; and
a scanning module, which is disposed below the transparent platen and is movable along a direction parallel to the right platen edge and the left platen edge so as to acquire an image of a document placed on the transparent platen.

2. The scanning device according to claim 1, wherein the document is a bound document, the right platen edge positions the bound document, which is opened and placed on the transparent platen and the right sloped plate, and the left platen edge positions the bound document, which is opened and placed on the transparent platen and the left sloped plate.

3. The scanning device according to claim 1, further comprising:
a positioning structure, which is disposed between the right platen edge and the left platen edge of the transparent platen, for positioning the document.

4. The scanning device according to claim 3, wherein the document is a bound document, the positioning structure and the right platen edge position the bound document, which is opened and placed on the transparent platen and the right sloped plate, and the positioning structure and the left platen edge position the bound document, which is opened and placed on the transparent platen and the left sloped plate.

5. The scanning device according to claim 1, further comprising an upper cover, which is attached to the base and is rotatable about an axis perpendicular to the left platen edge and the right platen edge such that the upper cover can be lifted up and closed on the transparent platen.
